(19) United States
(12) Patent Application Publication
(10) Pub. No.: US 2011/0091154 A1
(43) Pub. Date: Apr. 21, 2011

(54) Connecting structure and method able to make the signals transmit between multi-mode and single-mode fibers

(76) Inventor: Hui-Chin Chang, Taipei City (TW)

(21) Appl. No.: 12/588,416

(22) Filed: Oct. 15, 2009

(51) Int. Cl. G02B 6/26; G02B 6/02; G02B 6/36

(52) U.S. Cl. 385/28; 385/123; 385/53

(57) ABSTRACT

A connection structure and a method are provided for being able to make the signal of multi-mode fiber accepted by the single-mode fiber or to make the signal of single-mode fiber accepted by the multi-mode fiber. The present invention uses the core of the cladding of the single-mode fiber corresponding to that of multi-mode fiber in end-to-end relationship or uses the cladding of the single-mode fiber connects with that of multi-mode fiber in side-to-side relationship. Therefore, for users, it will not be necessary to use light-electricity converter between single-mode fiber and multi-mode fiber. In this way, the present invention can help to save the material cost and simplify the arrangement of the transmission line.

### BACKGROUND OF THE INVENTION

1. Field of the Invention

The present invention relates to a connection structure, or connector and a method able to make the signals transmit between multi-mode and single-mode fibers.

2. Description of Related Art

With the progressing high-speed voice and data communication era, optical fiber communication is indispensable communication technology for modern people. Generally speaking, the basic structure of optical fiber, fiber, optical fiber from inside to outside is divided into three distinct regions: a core, a cladding, and a coating. The optical fiber can be categorized generally as multi-mode fiber and single-mode fiber by how the optical fiber transmits the beam.

Please refer to FIG. 1A and FIG. 1B, generally speaking, the diameter of the core 1a of the multi-mode fiber is around 50 micrometer (μm). The diameter of the cladding 1b, which surrounds the core 1a, is around 125 μm. A beam/light 1c transmitting in the core 1a results in mode dispersion, as the beam 1c transmits in FIG. 1B. Therefore, the multi-mode fiber is suitable for short-distance transmission.

Please refer to FIG. 2A and FIG. 2B, generally speaking, the diameter of the core 2a of the single-mode fiber is around 9 μm. The diameter of the cladding 2b, which surrounds the core 2a, is around 125 μm. A beam 2c transmitting in the core 2a does not result in serious mode dispersion, as shown in the beam 2c transmits in FIG. 2B. Therefore, the single-mode fiber is suitable for long-distance transmission.

The difference between multi-mode fiber and single-mode fiber relies on the way the beam transmits in the core. The diameters of the cores corresponding to multi-mode fiber or single-mode fiber are generally only a common situation but not necessarily limited. The difference between multi-mode fiber and single-mode fiber lies in the way to polish and the incident angle of the beam entering the core. Additionally, regarding the male connector, it is common to surround a layer of ferro (i.e. a kind of ceramics) on the outside of the cladding for insertion.

To gain understanding signal generation for long-distance and conversion or reconversion between an electrical and optical wave transmission, please refer to FIG. 3, which displays a block diagram concerning to the multi-mode fiber and single-mode fiber application. A emitting terminal 3a emits a beam to a multi-mode fiber 3b; the beam transmits from the multi-mode fiber 3b to a first media converter 3c; the first media converter 3c transforms the beam into the electrical signal; the first media converter 3c further transforms the electrical signal into a beam which is available to transmit in a single-mode fiber 3d. The procedure just mentioned above was carried out in an indoor environment. The beam next transmits through the single-mode fiber 3d outdoors; the beam transmits to a second media converter 3e; the second media converter 3e transforms the beam into the electrical signal; the second media converter 3e further transforms the electrical signal into the beam which is applicable to transmit in a multi-mode fiber 3f. The beam finally transmits to a receiving terminal 3g, which processes in indoors. The receiving terminal 3g can transmit the signal to the emitting terminal 3a by a similar method.

However, the transformation among the multi-mode fiber 3b, 3f and the single-mode 3d needs the first media converter 3c and the second media converter 3e. In that way, users and/or suppliers need a lot of facilities whose cost is significant.

This inventor recognizes that the drawback is resolvable/solvable/. The inventor use his experience to contrive a reasonable invention to improve the drawback mentioned above.

### SUMMARY OF THE INVENTION

The main object of the present invention is to provide a connection structure and a method able to make the signals transmit between multi-mode and single-mode fibers, simplifying the arrangement of the transmission line and the facilities to reduce cost.

To attain the object mentioned above, as seen in the accompanying exemplary drawings, the present invention provides a connection structure able to make the signals transmit between multi-mode and single-mode fibers, comprising: a multi-mode male connector having a multi-mode column, the multi-mode column from inside to outside is divided into three distinct regions: a core, a cladding, and a ferro; a single-mode male connector having a single-mode column, the multi-mode column from inside to outside is divided into three distinct regions: a core, a cladding, and a ferro; and a female connector having an engaging portion; the multi-mode column and the single-mode column were further inserted into the two sides of the engaging portion, the core of the multi-mode column is corresponding to the core of the single-mode column.

The present invention further provides a female connector able to make the signals transmit between multi-mode and single-mode fibers, comprising: an engaging portion and a transferring portion, the transferring column is located in the engaging portion, the transferring column from inside to outside is divided into three distinct regions: a core, a cladding, and a ferro.

Then, the present invention further provides a method able to make the signals transmit between multi-mode and single-mode fibers, comprising following steps: (A) Offering a cladding of a multi-mode fiber; (B) Offering a cladding of a single-mode fiber; and (C) Connecting the cladding of the multi-mode fiber and the cladding of the single-mode fiber in side-to-side.

The present invention has many merits. People can use the core of the cladding of the single-mode fiber corresponding to that of multi-mode fiber in end-to-end relationship or uses the cladding of the single-mode fiber connects with that of multi-mode fiber in side-to-side relationship. It is unnecessarily to use media converters but connect the single-mode fiber and multi-mode fiber directly. Therefore, the present invention is helpful to save the material cost and simplify the arrangement of the transmission line.

To further understand the techniques, means, and effects the present invention applies for achieving the prescribed objectives, the following detailed description and appended drawings are hereby referenced, such that and through which, the purposes, features, and aspects of the present invention may be thoroughly and concretely appreciated; however, the appended drawings are merely provided for reference, illustration, and convenience, without intending any limitation of the true scope of the present invention.

### BRIEF DESCRIPTION OF THE DRAWINGS

FIG. 1A is a sectional view of the core and cladding of a multi-mode fiber in prior art;

FIG. 1B is a schematic view of the optical beam transmitting in the core and the cladding of the multi-mode fiber in prior art;

FIG. 2A is a sectional view of the core and cladding of a single-mode fiber in the prior art;

FIG. 2B is a schematic view of the optical beam transmitting in the core and the cladding of the single-mode fiber in the prior art;

FIG. 3 is a block diagram of the prior art;

FIG. 4 is a perspective view of the first embodiment of the present invention;

FIG. 5A is a partial and sectional view of the first embodiment of the present invention;

FIG. 5B is a partial enlargement view of FIG. 5A;

FIG. 6A is a partial and sectional view of the second embodiment of the present invention;

FIG. 6B is a partial enlargement view of FIG. 6A;

FIG. 7 is a schematic view of the third embodiment, a multi-mode fiber and a single-mode fiber connect side-to-side method, of the present invention.

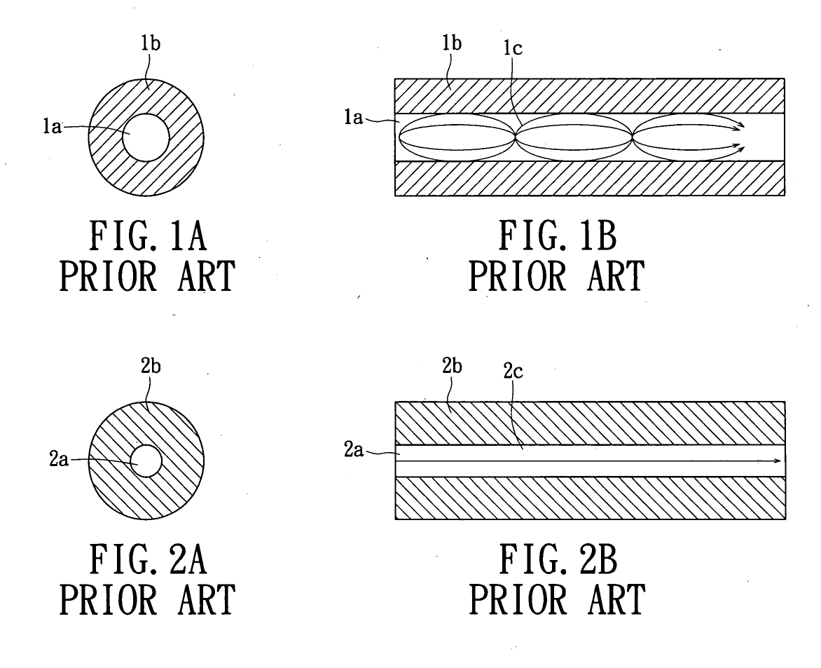

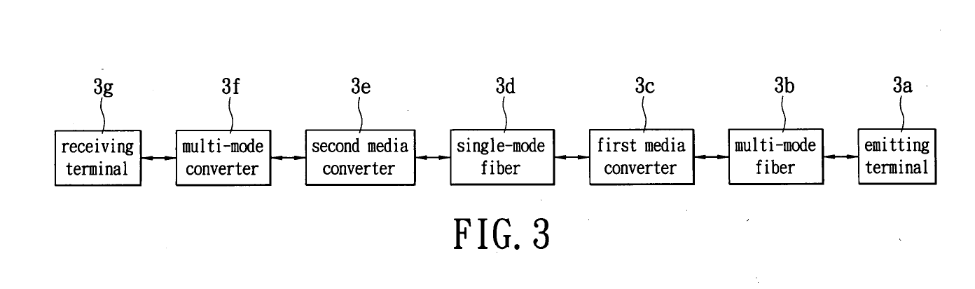

### DETAILED DESCRIPTION OF THE PREFERRED EMBODIMENTS

The present invention offers a connection structure and a method able to make the signals transmit between multi-mode and single-mode fibers.

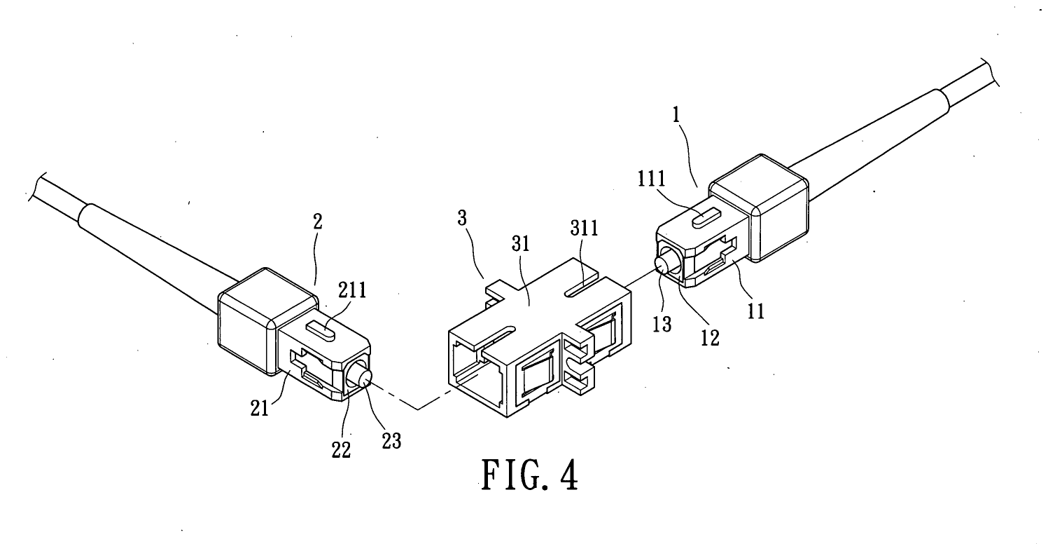

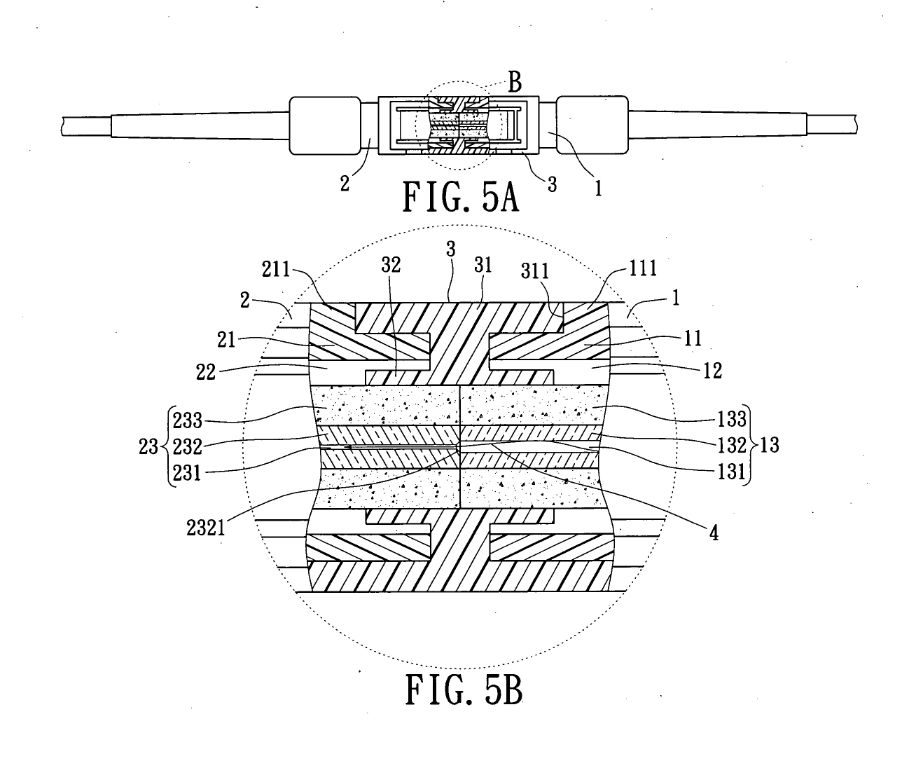

Please refer to FIG. 4 to FIG. 5A, 5B, the figures of the first embodiment. In the embodiment, the invention provides a connection structure able to make the signals transmit between multi-mode and single-mode fibers. The connection structure comprises a multi-mode male connector 1, a single-mode male connector 2 and a female connector 3. The multi-mode male connector 1 and the single-mode male connector 2 are inserted into two sides of the female connector 3.

The multi-mode male connector 1 has a shell 11, a surrounding portion 12, and a multi-mode column 13.

The shell 11 is a colloid with hollow. The shell 11 has a key 111 on its side. The key 111 is plate-shaped. The surrounding portion 12 is located in the shell 11. An end of the surrounding portion 12 is concave. A bottom of the end of surrounding portion 12 protrudes the multi-mode column 13. The multi-mode column 13 from inside to outside is divided into three distinct regions: a core 131, a cladding 132, and a ferro 133.

The single-mode male connector 2 has a shell 21, a surrounding portion 22, and a single-mode column 23.

The shell 21 is a colloid with hollow. The shell 21 has a key 211 on its side. The key 211 is plate-shaped. The surrounding portion 22 is located in the shell 21. An end of surrounding portion 22 is concave. A bottom of the end of surrounding portion 22 protrudes the single-mode column 23. The single-mode column 23 from inside to outside is divided into three distinct regions: a core 231, a cladding 232, and a ferro 233. An end of the cladding 232 has a guiding portion 2321, letting the diameter of the core 231 become comparably larger in the end.

The female connector 3 necessarily includes a housing 31 and an engaging portion 32. Two ends of the housing 31 locates have two keyways 311. The two keyways 311 accommodate the key 111 of the multi-mode male connector 1 and the key 211 of the single-mode male connector 2. The engaging portion 32 which is sleeve-like is located in the female connector 3. When the multi-mode male connector 1 and the single-mode male connector 2 are inserted into each of the two sides of the female connector 3, the multi-mode column 13 and the single-mode column 23 are further inserted into the two sides of the engaging portion 32. The end of multi-mode column 13 and the end single-mode column 23 contact with each other. The location of the core 131 is corresponding to that of the core 231. Because the end of the cladding 232 settled a guiding portion 2321, letting the core 131 and the core 231 in the interface with less difference in diameter.

A beam 4 can be reflected in the core 131 and transmitted into the end of the core 231, and the beam 4 can also be reflected in the core 231 and transmitted into the end of the core 131. In this way, the facilities, such as the first and the second media converters in convention can be obviated.

In the embodiment, the method able to make the signals transmit between multi-mode and single-mode fibers is described as follows:

(A) Providing a multi-mode male connector 1, the multi-mode male connector 1 has a multi-mode column 13. The multi-mode column 13 from inside to outside is divided into three distinct regions: a core 131, a cladding 132, and a ferro 133.

(B) Providing a single-mode male connector 2, the single-mode male connector 2 has a single-mode column 23. The single-mode column 23 from inside to outside is divided into three distinct regions: a core 231, a cladding 232, and a ferro 233.

(C) Providing a female connector 3, the female connector 3 has an engaging portion 32.

(D) Inserting the multi-mode male connector 1 and the single-mode male connector 2 into two sides of the female connector 3, wherein the multi-mode column 13 and the single-mode column 23 are inserted into two sides of the engaging portion 32, so that the location of the core 131 is corresponding to that of the core 231.

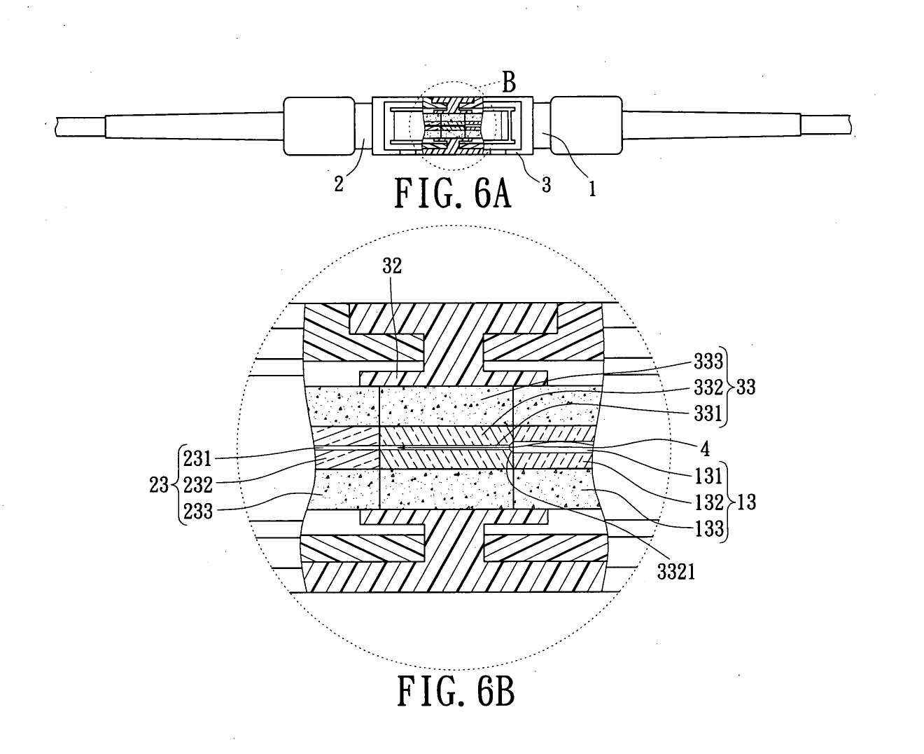

Please refer to FIG. 4 and FIG. 6A, 6B, the figures of the second embodiment. In the embodiment, the invention offers another connection structure able to make the signals transmit between multi-mode and single-mode fibers. The main differences between the first embodiment and the second embodiment are that the cladding 232 in second embodiment is unnecessarily to locate a guiding portion 2321 and the female connector 3 further includes a transferring column 33.

In the embodiment, the transferring column 33 is located in the engaging portion 32 of the female connector 3. The length of the engaging portion 32 is longer than the length of the transferring column 33. The multi-mode male connector 1 and the single-mode male connector 2 are still inserted into the two sides of the female connector 3. The transferring column 33, from inside to outside, is divided into three distinct regions: a core 331, a cladding 332, and a ferro 333. In the embodiment, the optical fiber of the transferring column 33 is single-mode fiber. The transferring column 33 is located between the multi-mode column 13 and the single-mode column 23. One end of the transferring column 33 contacts the multi-mode column 13 and the other end of the transferring column 33 contacts the single-mode column 23.

One end of the core 331 of the transferring column 33 is corresponding to the core 131 of the multi-mode column 13. One end of the cladding 332 of the transferring column 33 is located at a guiding portion 3321, such as by creation of a chamfer or other guiding means. The other end of the core 331 of the transferring column 33 is corresponding to the core 231 of the single-mode column 23.

In the embodiment, the connection structure and the method that are able to make the signals transmit between multi-mode and single-mode fibers are similar to the first embodiment. The difference is that the female connector 3 has the transferring column 33, which is located between the multi-mode column 13 and the single-mode column 23.

“Corresponding” mentioned above means that the multi-mode fibers and the single-mode fibers are in functional proximity such that transmittance from one to the other is successful with no more than acceptable signal loss.

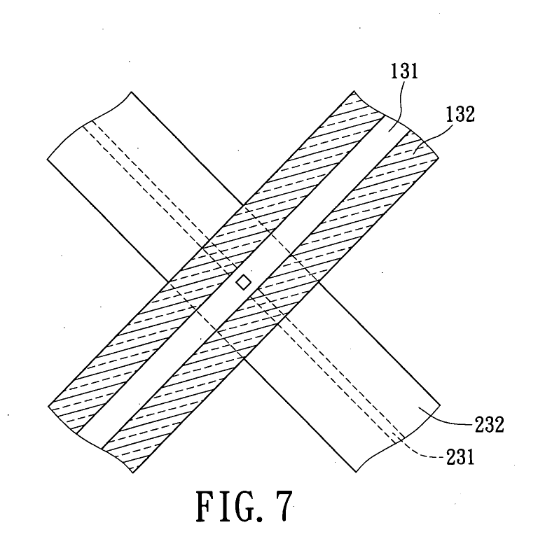

Besides the end-to-end relationship between the multi-mode fiber and the single-mode fiber to transmit the beam/signal, the invention further includes another way. Please refer to FIG. 7, where the third embodiment of the present invention is shown.

In the third embodiment, the invention offers another connection structure able to make the signals transmit between the multi-mode and single-mode fibers. Compared with the first and second embodiment, the cladding 132 of the multi-mode fiber and the cladding 232 of the single-mode fiber are not connected with end-to-end form. The side of the cladding 132 is connected with the side of the cladding 232. Since the cladding 132 and the cladding 232 are transparent material, the beam/signal can transmit from the cladding 132 to the cladding 232 when the cladding 132 and the cladding 232 overlap with each other. Similarly, the beam/signal can transmit from the cladding 232 to the cladding 132.

The invention offers another connection method able to make the signals transmit between the multi-mode and single-mode fibers. The cladding 132 and the cladding 232 are connected with each other by melted in side-to-side.

To sum up, the present invention applies end-to-end relationship corresponding or melted in side-to-side for the multi-mode and single-mode connection. The methods are helpful to obviate the media converters and help the signal to transmit directly. The present invention helps obviate extra cost.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A connection structure able to make the signals transmit between multi-mode and single-mode fibers, comprising:
a multi-mode male connector having a multi-mode column, wherein the multi-mode column is divided into three distinct regions: a core, a cladding, and a ferro from an inside to an outside thereof;
a single-mode male connector having a single-mode column, wherein the multi-mode column is divided into three distinct regions: a core, a cladding, and a ferro from an inside to an outside thereof; and
a female connector having an engaging portion, the multi-mode column and the single-mode column respectively inserted into two sides of the engaging portion, the core of the multi-mode column is corresponding to the core of the single-mode column.

2. The connection structure as claimed in claim 1, wherein an end of the multi-mode column and an end of the single-mode column contact with each other, and the cladding of the single-mode column has a guiding portion formed on an inner side of an end thereof.

3. The connection structure as claimed in claim 1, wherein the female connector includes a transferring column, and the transferring column has a core, a cladding, and a ferro.

4. The connection structure as claimed in claim 3, wherein the transferring column is located in the engaging portion of the female connector, one end of the core of the transferring column is corresponding to the core of the multi-mode column, and the other end of the core of the transferring column is corresponding to the core of the single-mode column.

5. The connection structure as claimed in claim 4, wherein one end of the transferring column contacts to the multi-mode column, and the other end of the transferring column contacts to the single-mode column.

6. A female connector able to make the signals transmit between multi-mode and single-mode fibers, comprising: an engaging portion and a transferring portion, the transferring column is located in the engaging portion, wherein the transferring column is divided into a core, a cladding and a ferro from an inside to an outside thereof.

7. The female connector as claimed in claim 6, wherein the cladding of the transferring column has a guiding portion formed on an inner side of an end thereof.

8. A method able to make the signals transmit between multi-mode and single-mode fibers, comprising following steps:
providing a cladding of a multi-mode fiber;
providing a cladding of a single-mode fiber; and
connecting an end of the cladding of the multi-mode fiber to an end of the cladding of the single-mode fiber.

9. The method as claimed in claim 8, the cladding of the multi-mode fiber and the cladding of the single-mode fiber are connected with each other by melted in side-to-side.
